(19) United States
(12) Patent Application Publication
(10) Pub. No.: US 2017/0232992 A1
(43) Pub. Date: Aug. 17, 2017

(54) CHILD STROLLER SYSTEM

(71) Applicant: Fateha Chowdhury, Ilford (GB)

(72) Inventor: Fateha Chowdhury, Ilford (GB)

(21) Appl. No.: 15/486,290

(22) Filed: Apr. 12, 2017

Related U.S. Application Data
(63) Continuation-in-part of application No. 15/045,533, filed on Feb. 17, 2016.

(51) Int. Cl. B62B 7/10; B62B 9/10; B62B 9/12; B62B 9/20; B62B 9/26

(52) U.S. Cl. CPC B62B 7/10; B62B 9/20; B62B 9/26; B62B 9/12; B62B 9/102; B62B 2205/20

(57) ABSTRACT

A child stroller system having a frame-assembly including a frame, a plurality of wheels, and a push-handle. The seat-assembly includes a seat and a seat-mounting-bracket, a storage bag support-assembly including a storage-bag and a bag-mount-member. The frame-assembly, the seat-assembly, and the storage bag support assembly in functional combination allow the seat to swing-rotate in relation to the frame and the bag-mount-member providing a resting platform for the storage-bag. The frame-assembly supports the seat-assembly and the storage bag support-assembly such that a child and stored items are able to be transported simultaneously. The child stroller system further includes a kinesthetic toy attached to the seat to provide amusement for said child.

### CROSS REFERENCE TO RELATED APPLICATION

The present application is a Continuation-in-Part and is related to and claims priority to pending U.S. patent application Ser. No. 15/045,533 filed Feb. 17, 2016, which is incorporated by reference herein in its entirety.

### BACKGROUND OF THE INVENTION

The following includes information that may be useful in understanding the present disclosure. It is not an admission that any of the information provided herein is prior art nor material to the presently described or claimed inventions, nor that any publication or document that is specifically or implicitly referenced is prior art.

1. Field of the Invention

The present invention relates generally to the field of strollers and more specifically relates to child stroller system.

2. Description of Related Art

Various methods of transporting children have been used in different cultures and times. Baby strollers may be used but are often not multi-purpose. Swings may be used to entertain and sooth children. A need exists for a functional and durable baby stroller. A suitable solution is desired.

U.S. Pub. No. 2013/0334781 to Mills relates to an infant stroller and swing combination. The described infant stroller and swing combination includes a stroller, which includes a chassis having first and second opposing frame elements; a seat suspended from said chassis by way of first and second support elements; wherein the seat includes upper and lower portions and is adapted to accommodate a child such that the back of the child rests against the upper portion and such that the legs of the child rest against the lower portion. The first and second support elements are rotatably attached to said first and second frame elements; wherein the first support element extends under the lower portion of the seat; and a motor which rotates the first support element.

### BRIEF SUMMARY OF THE INVENTION

In view of the foregoing disadvantages inherent in the known land vehicles art, the present disclosure provides a novel child stroller system. The general purpose of the present disclosure, which will be described subsequently in greater detail, is to provide a child transporting device and storage for items simultaneously.

A child stroller system is disclosed herein. The child stroller system includes a frame-assembly including a frame, a plurality of wheels, and a push-handle. The seat-assembly includes a seat and a seat-mounting-bracket, a storage bag support-assembly including a storage-bag, and a bag-mount-member. The frame-assembly, the seat-assembly, and the storage bag support-assembly in functional combination are configured to allow the seat to swing-rotate in relation to the frame when desired. The swing action is provided via suitable means known in the art (axles or the like) such that the seat is able to swing in an arc in relation to the frame, yet the frame remaining stationary. In this way the child is able to swing for comforting and soothing purposes. The swing may be locked when swinging is not desirable. The bag-mount-member provides a resting platform for the storage-bag. The frame-assembly supports the seat-assembly and the storage bag support-assembly such that a child and stored items are able to be transported simultaneously.

The child stroller system is collapsible; the seat-assembly and the storage bag support-assembly able to be removably coupled and decoupled from the frame-assembly. The seat is able to swing-rotate in relation to the frame about a centerline parallel with axles for the plurality of wheels. Relationally speaking, the storage bag support-assembly is mounted behind the seat-assembly during use. The seat-assembly is frontwardly-offset mounted to provide adequate room such that items are able to be added and removed from the storage-bag with relative ease. The storage-bag is able to hold up to fifteen kilograms of items yet maintaining a non-tip condition of the child stroller system. The bag-mount-member comprises a clippable-tray. Further, the storage-bag is flexible.

The push-handle is adjustable between a raised-position and a lowered-position. The push-handle is able to be locked via at least one first-lock-member. The seat is able to be locked in a static position via at least one second-lock-member. The seat-mounting-bracket is removable from the frame. A front-axle is narrower in width than a rear-axle such that stability is maximized during use. The storage-bag comprises handles. The frame-assembly supports the seat-assembly and the storage bag support-assembly such that a child and stored items are able to be transported simultaneously.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and methods of use for the present disclosure, a child stroller system, constructed and operative according to the teachings of the present disclosure.

FIG. 1 is a front perspective view of the child stroller system during an ‘in-use’ condition, according to an embodiment of the disclosure.

FIG. 2 is a perspective view of the child stroller system of FIG. 1, according to an embodiment of the present disclosure.

FIG. 3A is another perspective view of the child stroller system of FIG. 1, according to an embodiment of the present disclosure.

FIG. 3B is another perspective view of the child stroller system of FIG. 1, according to an embodiment of the present disclosure.

FIG. 4 is a perspective view of the child stroller system of FIG. 1, according to an embodiment of the present disclosure.

FIG. 5 is a perspective view of the child stroller system of FIG. 1, according to an embodiment of the present disclosure.

The various embodiments of the present invention will hereinafter be described in conjunction with the appended drawings, wherein like designations denote like elements.

### DETAILED DESCRIPTION

As discussed above, embodiments of the present disclosure relate to a strollers and more particularly to a child stroller system as used to improve the means by which children are able to be transported and entertained.

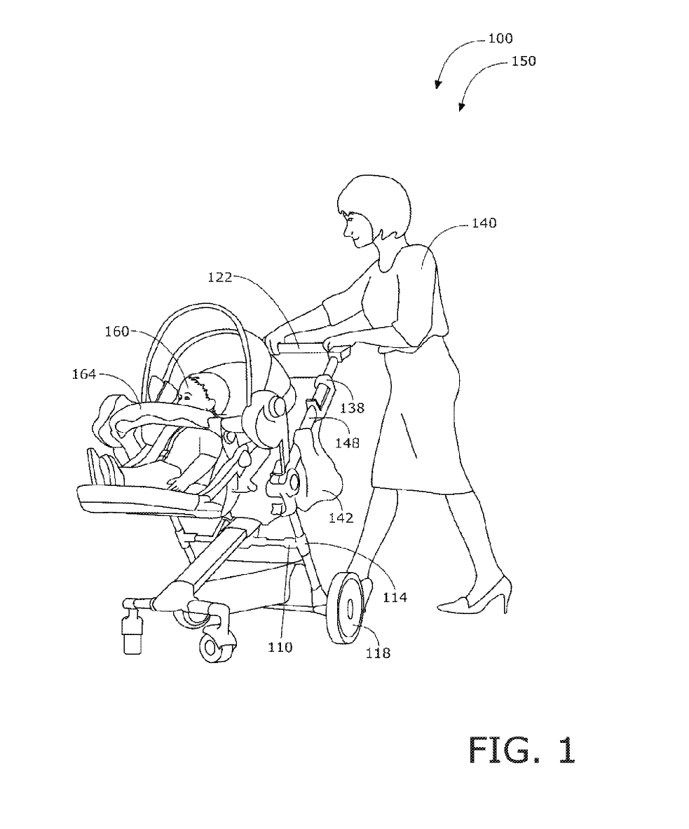

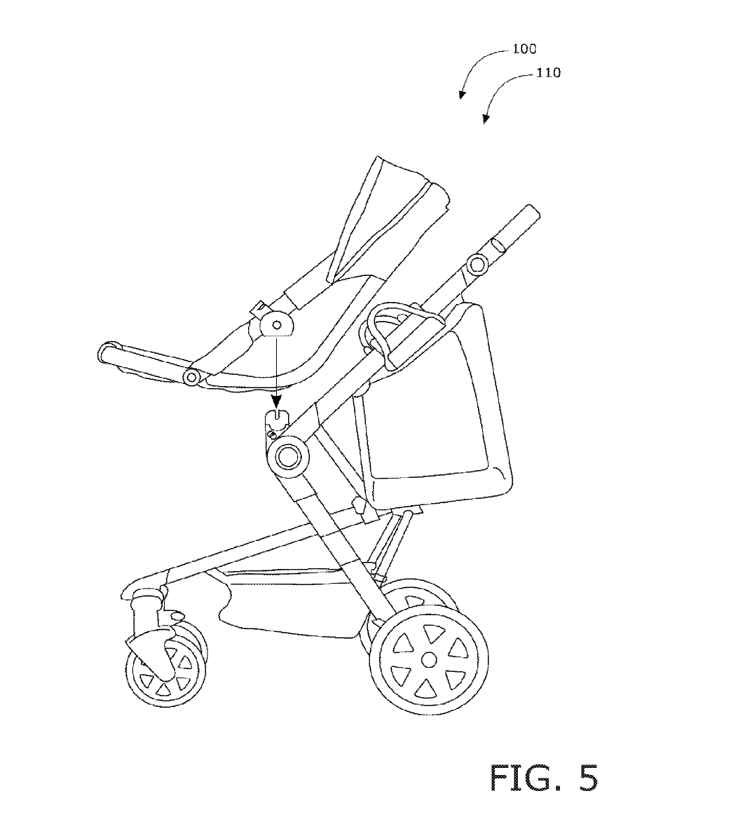

Referring now more specifically to the drawings by numerals of reference, there is shown in FIGS. 1-5, various views of a child stroller system 100. FIG. 1 shows a child stroller system 100 during an ‘in-use’ condition 150, according to an embodiment of the present disclosure. As Illustrated, the child stroller system 100 may include a frame-assembly 110 including a frame 114, a plurality of wheels 118, and a push-handle 122, a seat-assembly 126 including a seat 130 and a seat-mounting-bracket 134, a storage bag support-assembly 138 including a storage-bag 142 and a bag-mount-member 148. The frame-assembly 110, the seat-assembly 126, and the storage bag support-assembly 138 in functional combination are configured to allow the seat 130 to swing-rotate in relation to the frame 114 and the bag-mount-member 148 providing a resting platform for the storage-bag 142. The frame-assembly 110 supports the seat-assembly 126 and the storage bag support-assembly 138 such that a child 160 and stored items are able to be transported simultaneously.

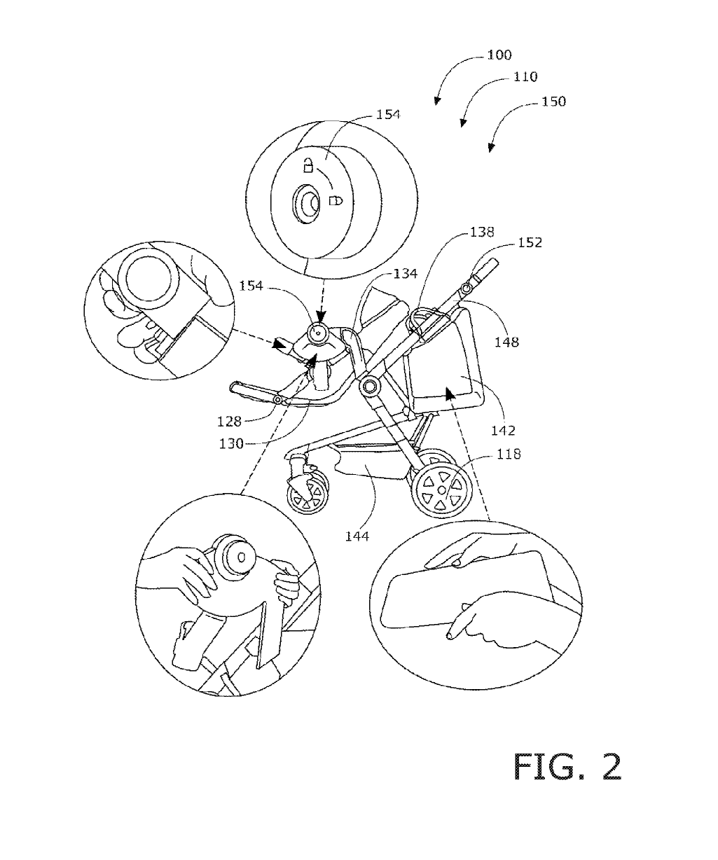

FIG. 2 shows a perspective view of the child stroller system 100 of FIG. 1, according to an embodiment of the present disclosure. As above, the child stroller system 100 may include the seat-assembly 126 and the storage bag support-assembly 138. The child stroller system 100 is collapsible. The seat-assembly 126 and the storage bag support-assembly 138 are able to be removably coupled and decoupled from the frame-assembly 110. The seat 130 is able to swing-rotate in relation to the frame 114 about a centerline parallel with axles for the plurality of wheels 118. The storage bag support-assembly 138 is mounted behind the seat-assembly 126 during use. The seat-assembly 126 is frontwardly-offset mounted to provide adequate room such that items are able to be added and removed from the storage-bag 142 with relative ease. The storage-bag 142 is able to hold up to fifteen kilograms of items yet maintaining a non-tip condition of the child stroller system. The bag-mount-member 148 comprises a clippable-tray. The storage-bag is flexible 142.

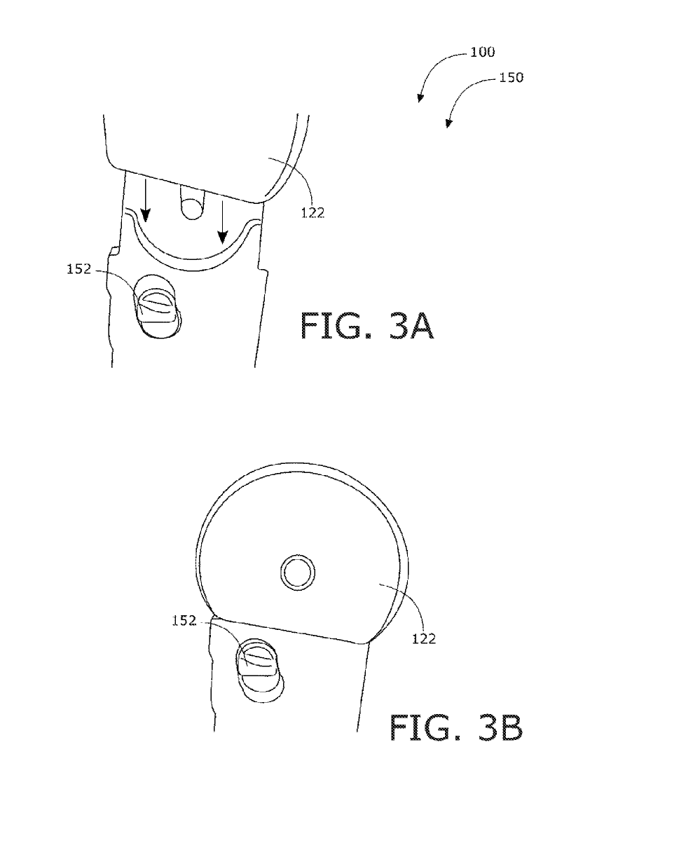

FIG. 3 shows a perspective view of the child stroller system 100 of FIG. 1, according to an embodiment of the present disclosure. As above, the child stroller system 100 may further comprising a lower-storage basket 144. The push-handle 122 is adjustable between a raised-position and a lowered-position. The push-handle 122 is able to be locked via at least one first-lock-member 152. The seat 130 is able to be locked in a static position via at least one second-lock-member 154. The seat-mounting-bracket 134 is removable from the frame 114. A front-axle is narrower in width than a rear-axle such that stability is maximized during use. The child stroller system 100 may further comprise a kinesthetic toy 164 attached to the seat 130 configured to provide amusement for the child 160. The kinesthetic toy 164 includes beads that are able to move along a channel The storage-bag 142 preferably comprises handles.

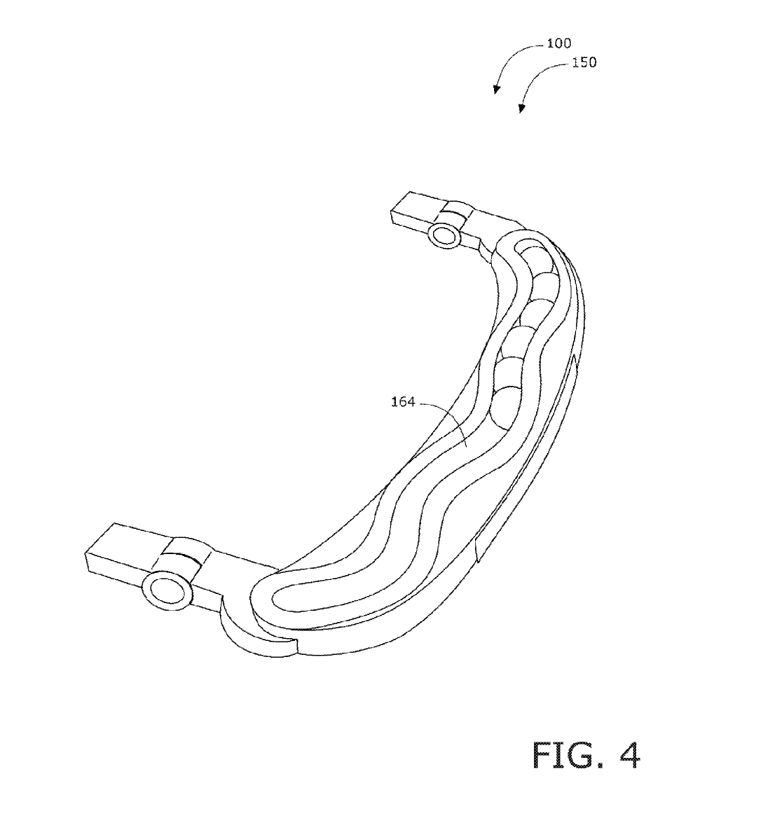

FIG. 4 shows a perspective view of the child stroller system 100 of FIG. 1, according to an embodiment of the present disclosure. As above, the child stroller system 100 may include a frame-assembly 110 having a frame 114, a plurality of wheels 118, and a push-handle 122, a seat-assembly 126 including a seat 130, and a seat-mounting-bracket 134, a storage bag support-assembly 138 including a storage-bag 142, a lower-storage basket 144, and a bag-mount-member 148, and a kinesthetic toy 164 attached to the seat 130 configured to provide amusement for a child 160. The child stroller system 100 is collapsible in a preferred embodiment. The seat-assembly 126 and the storage bag support-assembly 138 able to be removably coupled and decoupled from the frame-assembly 110. The seat 130 is able to swing-rotate in relation to the frame 114 about a centerline parallel with axles for the plurality of wheels 118.

The storage bag support-assembly 138 is mounted behind the seat-assembly 126 during use. The seat-assembly 126 is frontwardly-offset mounted to provide adequate room such that items are able to be added and removed from the storage-bag 142 with relative ease. The storage-bag 142 is able to hold up to fifteen kilograms of the items yet maintaining a non-tip condition of the child stroller system 100. The bag-mount-member 148 comprises a clippable-tray. The push-handle 122 is adjustable between a raised-position and a lowered-position and able to be locked via at least one first-lock-member 152. The seat 130 is able to be locked in a static position via at least one second-lock-member 154. The seat-mounting-bracket 134 is removable from the frame 114. Frame-assembly 110 supports the seat-assembly 126 and the storage bag support-assembly 138 such that a child 160 and stored items are able to be transported simultaneously.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

1. A child stroller system, the system comprising:
a frame-assembly including;
a frame;
a plurality of wheels; and
a push-handle;
a seat-assembly including;
a seat; and
a seat-mounting-bracket;
a storage bag support-assembly including;
a storage-bag; and
a bag-mount-member;
wherein said frame-assembly, said seat-assembly, and said storage bag support-assembly in functional combination are configured to allow said seat to swing-rotate in relation to said frame, and said bag-mount-member providing a resting platform for said storage-bag; and
wherein said frame-assembly supports said seat-assembly and said storage bag support-assembly such that a child and stored items are able to be transported simultaneously.

2. The child stroller system of claim 1, wherein said child stroller system is collapsible, said seat-assembly and said storage bag support-assembly able to be removably coupled and decoupled from said frame-assembly.

3. The child stroller system of claim 2, wherein said seat is able to swing-rotate in relation to said frame about a centerline parallel with axles for said plurality of wheels.

4. The child stroller system of claim 3, wherein said storage bag support-assembly is mounted behind said seat-assembly during use.

5. The child stroller system of claim 4, wherein said seat-assembly is frontwardly-offset mounted to provide adequate room such that items are able to be added and removed from said storage-bag with relative ease.

6. The child stroller system of claim 5, wherein the storage-bag is able to hold up to fifteen kilograms of said items yet maintaining a non-tip condition of said child stroller system.

7. The child stroller system of claim 6, wherein the bag-mount-member comprises a clippable-tray.

8. The child stroller system of claim 7, wherein the storage-bag is flexible.

9. The child stroller system of claim 8, further comprising a lower-storage basket.

10. The child stroller system of claim 9, wherein the push-handle is adjustable between a raised-position and a lowered-position.

11. The child stroller system of claim 10, wherein the push-handle is able to be locked via at least one first-lock-member.

12. The child stroller system of claim 11, wherein the seat is able to be locked in a static position via at least one second-lock-member.

13. The child stroller system of claim 12, wherein the seat-mounting-bracket is removable from said frame.

14. The child stroller system of claim 13, wherein a front-axle is narrower in width than a rear-axle such that stability is maximized during use.

15. The child stroller system of claim 14, further comprising a kinesthetic toy attached to said seat configured to provide amusement for said child.

16. The child stroller system of claim 15, wherein the storage-bag comprises handles.

17. A child stroller system, the system comprising:
a frame-assembly including;
a frame;
a plurality of wheels; and
a push-handle;
a seat-assembly including;
a seat; and
a seat-mounting-bracket;
a storage bag support-assembly including;
a storage-bag;
a lower-storage basket; and
a bag-mount-member; and
a kinesthetic toy attached to said seat configured to provide amusement for a child;
wherein said frame-assembly, said seat-assembly, and said storage bag support-assembly in functional combination are configured to allow said seat to swing-rotate in relation to said frame, and said bag-mount-member providing a resting platform for said storage-bag;
wherein said child stroller system is collapsible, said seat-assembly and said storage bag support-assembly able to be removably coupled and decoupled from said frame-assembly;
wherein said seat is able to swing-rotate in relation to said frame about a centerline parallel with axles for said plurality of wheels;
wherein said storage bag support-assembly is mounted behind said seat-assembly during use;
wherein said seat-assembly is frontwardly-offset mounted to provide adequate room such that items are able to be added and removed from said storage-bag with relative ease;
wherein said storage-bag is able to hold up to fifteen kilograms of said items yet maintaining a non-tip condition of said child stroller system;
wherein the bag-mount-member comprises a clippable-tray;
wherein the storage-bag is flexible;
wherein said push-handle is adjustable between a raised-position and a lowered-position;
wherein the push-handle is able to be locked via at least one first-lock-member;
wherein the seat is able to be locked in a static position via at least one second-lock-member;
wherein the seat-mounting-bracket is removable from said frame;
wherein a front-axle is narrower in width than a rear-axle such that stability is maximized during use;
wherein the storage-bag comprises handles; and
wherein said frame-assembly supports said seat-assembly and said storage bag support-assembly such that a child and stored items are able to be transported simultaneously.
